(19) United States
(12) Patent Application Publication
(10) Pub. No.: US 2023/0302481 A1
(43) Pub. Date: Sep. 28, 2023

(54) ADJUSTABLE HIGH REACH SPRINKLER HEAD

(71) Applicant: Span & Company LLC, Miami, FL (US)

(72) Inventor: Mark K. Greenspan, Miami, FL (US)

(73) Assignee: Span & Company LLC, Miami, FL (US)

(21) Appl. No.: 18/127,292

(22) Filed: Mar. 28, 2023

Related U.S. Application Data
(60) Provisional application No. 63/324,577, filed on Mar. 28, 2022.

(51) Int. Cl. B05B 15/68; B05B 15/65

(52) U.S. Cl. CPC B05B 15/68; B05B 15/65

(57) ABSTRACT

A high reach sprinkler head includes a base connectable to an irrigation line, a body pivotably connected to the base, and a nozzle connector rotatably connected to the body. A nozzle is connectable to the nozzle connector so that the sprinkler head waters plants higher than conventional sprinkler heads to provide irrigation to plants that are mounted to trees or other structures not rooted in soil. The sprinkler head's adjustable pivot allows the user to customize the angle of spray and the desired height of the spray's reach. The user can customize the pivot at any time to water plants at different heights. The top section of the sprinkler head rotates 360° to allow the user to direct the water to different locations. The base can also rotate 360° relative to the irrigation line to allow the user to direct water to locations further away from the sprinkler head.

### FIELD OF THE INVENTION

The invention relates to an adjustable high reach sprinkler head used, for example, to irrigate orchids.

### BACKGROUND

Sprinkler irrigation is the application of water under pressure to plants through nozzles often attached to sprinkler heads. There are various types of sprinklers heads used in irrigation. They are used to water different types of plants which are planted in the ground such as trees, grass and shrubs.

The main types of sprinkler heads are: irrigation heads, spray rotary heads, bubbler irrigation heads, and drop or soaker systems. Each different type head will water plants in a particular way.

For example, orchids, which are epiphytic (i.e. growing attached to other plants, trees, or rocks, etc.), survive on moisture and nutrients in the atmosphere and therefore have different irrigation requirements than the trees or plants on which they grow. Often, the orchids are attached to the tree or plant at heights well above the ground. As a result, complex, cumbersome, and unsightly irrigation systems have been used for irrigation of orchids.

There therefore exists a need for an improved sprinkler head such as the sprinkler head disclosed herein that can water plants that are out of reach of conventional sprinkler heads.

### SUMMARY OF THE INVENTION

One aspect of the present invention relates to an adjustable sprinkler head comprising: a base with a first end connectable to an irrigation line through which water is supplied to the sprinkler head and a second end opposite the first end; a body pivotably connected to the second end of the base at a first end of the body so that the body is adjustably pivotable relative to the base; and a nozzle connector rotatably connected at a first end to a second end of the body so that the nozzle connector is adjustably rotatable relative to the body. A nozzle is connectable to a second end of the nozzle connector, and the supplied water travels through a base conduit in the base into a body conduit in the body, then into a nozzle connector conduit in the nozzle connector, and out a nozzle connected to the nozzle connector.

A first end of the base can be threaded for threadably connecting the base to the irrigation line. The body can be adjustably pivotable from about 120 degrees to about 180 degrees relative to the base. The nozzle connector can be adjustably rotatable 360 degrees relative to the body. The second end of the nozzle connector can be threaded for threadably connecting the nozzle connector to the nozzle.

In an embodiment, the second end of the base includes a nub having a flange creating an area of lesser diameter and an O ring on the area. The first end of the body has a rim for accommodating a retainer. The retainer has cutouts so that the retainer is resiliently bendable inward as the retainer is introduced into the second end of the base and resiliently snappable back outward once the retainer is inserted sufficiently to be on the area of lesser diameter of the second end of the base. In some embodiments, the retainer is integrally formed with the body. In other embodiments, the retainer is separately formed from the body and the retainer is resiliently bendable inward as the retainer is introduced into the first end of the body and resiliently snappable back outward once the retainer is inserted past the rim and wherein the retainer is welded or glued to the body. At least one of the base and the body can be provided with knurling.

In an embodiment, a first end of the nozzle connector is provided with a nipple having a connector flange creating a nipple area of lesser diameter and an O ring on the nipple area. The second end of the body has a body rim for accommodating a body retainer. The body retainer has cutouts so that the body retainer is resiliently bendable inward as the body retainer is introduced into the first end of the nozzle connector and resiliently snappable back outward once the body retainer is inserted sufficiently to be on the lesser diameter of nipple area. If the body retainer is separately formed from the body, the body retainer is resiliently bendable inward as the body retainer is introduced into the second end of the body and resiliently snappable back outward once the body retainer is inserted past the body rim. The body retainer is welded, glued, or otherwise attached to the body. At least one of the nozzle connector and the body can be provided with knurling.

In an embodiment, the base comprises a first portion and a second portion. The first portion includes the first end of the base connectable to the irrigation line so that the first portion is rotatable relative to the irrigation line and the second portion includes the second end of the base so that the second portion of the base is pivotably connected to the body. In exemplary embodiments, a second end of the first portion is provided with a base nipple having a base flange creating an area of lesser diameter of the base nipple and an O ring on the area of the base nipple. A base retainer is resiliently bendable inward as the base retainer is introduced into the second portion and resiliently snappable back outward. The base retainer resiliently bends inward as the base retainer is introduced into the first portion and resiliently snappable back outward once the base retainer is inserted sufficiently to be on the lesser diameter of the area of the base nipple.

In a preferred embodiment, an adjustable sprinkler head comprises: a base with a first end connectable to an irrigation line through which water is supplied to the sprinkler head and a second end opposite the first end; a body pivotably connected to the second end of the base at a first end of the body so that the body is adjustably pivotable relative to the base; and a nozzle connector rotatably connected at a first end to a second end of the body so that the nozzle connector is adjustably rotatable relative to the body. A nozzle is connectable to a second end of the nozzle connector, with the supplied water travelling through a base conduit in the base into a body conduit in the body, then into a nozzle connector conduit in the nozzle connector, and out a nozzle connected to the nozzle connector. The second end of the base includes a nub having a flange creating an area of lesser diameter and an O ring on the area. The first end of the body has a rim for accommodating a retainer. The retainer has cutouts so that the retainer is resiliently bendable inward as the retainer is introduced into the first end of the body, resiliently snappable back outward once the retainer is inserted past the rim. The retainer is welded, glued, or otherwise attached to the body. The retainer is resiliently bendable inward as the retainer is introduced into the second end of the base and resiliently snappable back outward once the retainer is inserted sufficiently to be on the area of lesser diameter of the second end of the base. A first end of the nozzle connector is provided with a nipple having a connector flange creating a nipple area of lesser diameter and an O ring on the nipple area. The second end of the body has a body rim for accommodating a body retainer. The body retainer has cutouts so that the body retainer is resiliently bendable inward as the body retainer is introduced into the second end of the body, resiliently snappable back outward once the body retainer is inserted past the body rim. The body retainer is welded, glued, or otherwise attached to the body once inserted past the body rim. The body retainer is resiliently bendable inward as the body retainer is introduced into the first end of the nozzle connector and resiliently snappable back outward once the body retainer is inserted sufficiently to be on the lesser diameter of nipple area. The body is adjustably pivotable from about 120 degrees to about 180 degrees relative to the base and the nozzle connector is adjustably rotatable 360 degrees relative to the body.

### BRIEF DESCRIPTION OF THE DRAWINGS

A more complete understanding of the present disclosure, and the attendant advantages and features thereof, will be more readily understood by reference to the following description when considered in conjunction with the accompanying drawings wherein:

FIG. 1 shows a side view of an embodiment of a high reach sprinkler head according to the present invention.

FIG. 2 shows an isometric exploded view of the high reach sprinkler of FIG. 1.

FIG. 3 shows a side exploded view of the high reach sprinkler of FIG. 1 with the internal conduits shown.

FIG. 4 shows an exploded view of another embodiment of a high reach sprinkler head according to the present invention.

### DETAILED DESCRIPTION

As required, embodiments are disclosed herein; however, it is to be understood that the disclosed embodiments are merely examples and that the devices and methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

It can be advantageous to set forth definitions of certain words and phrases used throughout this disclosure. The terms “a” or “an”, as used herein, are employed to describe elements and components described herein. This is done merely for convenience and to give a general sense of the scope of the disclosure. This description should be read to include one or at least one and the singular also includes the plural unless it is obvious that it is meant otherwise. The term “plurality”, as used herein, is defined as two or more than two. The term “another”, as used herein, is defined as at least a second or more. The term “coupled,” as used herein, is defined as “connected,” although not necessarily directly, and not necessarily mechanically.

The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A; B; C; A and B; A and C; B and C; and A, B, and C.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skilled in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Note that not all of the activities described in the general description or the examples are required, that a portion of a specific activity may not be required, and that one or more further activities can be performed in addition to those described. Still further, the order in which activities are listed are not necessarily the order in which they are performed.

In general, the invention relates to an adjustable high reach sprinkler head.

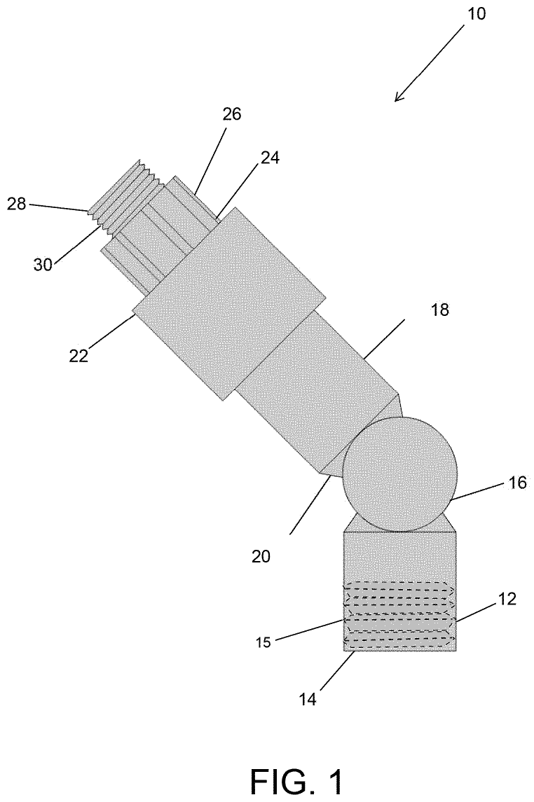

FIG. 1 is a schematic representation of a first embodiment of a sprinkler head 10. A base 12 has a threaded end 14 (with threads 15 shown in phantom) for connection to the irrigation line through which water or any other irrigation fluid is provided to sprinkler head 10. In preferred embodiments, threaded end 14 is a female ½ inch NPT thread which allows it to fit standard ½ inch irrigation systems. The present invention contemplates other size threading or other suitable coupling mechanisms.

At an opposite end 16, base 12 is pivotably connected to a body 18 of sprinkler head 10. In preferred embodiments, body 18 can pivot anywhere from about 120 degrees to about 180 degrees relative to base 12 and, as a result, water plants several feet higher than current common sprinkler heads. This allows mounting of plant material in elevations many feet higher while still able to receive the needed water to be maintained. Because the pivot is adjustable, as opposed to current sprinkler heads that are mounted in a fixed position, sprinkler head 10 can pivot to account for continued growth of plants.

The pivot connection between base 12 and body 18 is located at a lower end 20 of body 18. At an upper end 22 of body 18, a first end 24 of a nozzle connector 26 is rotatably connected to body 18. In preferred embodiments, the nozzle connector 26 can rotate 360 degrees relative to body 18. This enables a single sprinkler head 10 to water plant material mounted at elevated heights on adjacent trees by rotating nozzle connector 26 to aim at the desired location. Because of its ability to rotate, a single sprinkler head 10 can satisfy irrigation needs that would take several conventional fixed sprinkler heads to cover.

A second end 28 of nozzle connector 26 is threaded for connection to a nozzle. The present invention contemplates that the nozzle connected to nozzle connectoer 26 can be any suitable nozzle such as a fixed spray nozzle or a rotor nozzle as one of ordinary skill in the art would appreciate. In preferred embodiments, threading 30 is a male ½ inch NPT thread which allows the flexibility to accommodate most, if not all, standard nozzle adapters. The present invention contemplates other size threading or other suitable coupling mechanisms. In other words, sprinkler head 10 is designed to provide the flexibility to attach to an array of common landscape nozzle adapters thereby allowing the attachment of any common landscape nozzle to determine the spray pattern, angle of the spray, and distance the water is projected.

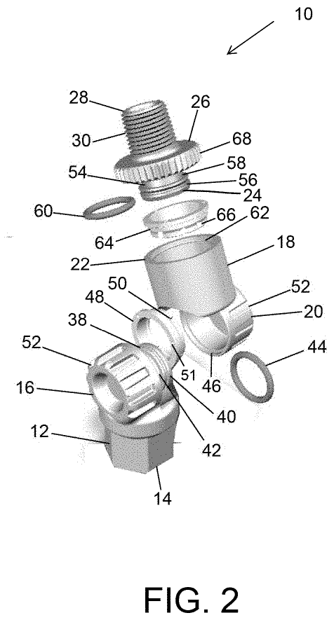

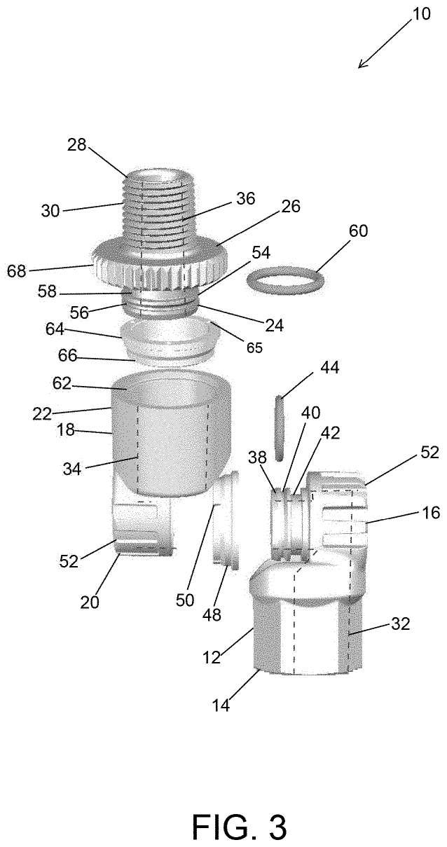

FIGS. 2 and 3 are exploded views of high reach sprinkler head 10 showing one embodiment of the components that provide the 120°-180° pivot as well as the 360° rotation. Water travels through a conduit 32 in base 12 into a conduit 34 in body 18, then into a conduit 36 in nozzle connector 26, and out a nozzle connected to nozzle connector 26.

End 16 of base 12 is provided with a nub 38 having a flange 40 creating an area 42 of lesser diameter. An O ring 44 on area 42 helps make the pivotable coupling between base 12 and body 18 fluid tight. Lower end 20 of body 18 has a rim 46 for accommodating a retainer 48. In particular, retainer 48 has cutouts 50 so that retainer 48 can resiliently bend inward as it is introduced into lower end 20 of body 18 and resiliently snap back outward once it is inserted past rim 46. Similarly, retainer 48 can resiliently bend inward as it is introduced into end 16 of base 12 and resiliently snap back outward once it is inserted sufficiently to be on the lesser diameter of area 42. To facilitate pivoting of body 18 relative to base 12, at least one of base 12 and body 18 can be provided with knurling 52.

For manufacturing purposes, retainer 48 can be made integral to body 18. For example, using 3D printing, a single piece is formed in which retainer 48 is an integral part of body 18. Retainer 48 can also be made separately using, for example, injection molding in which retainer 48 is snapped into body 18 and then glued or welded (e.g. spin welding or ultrasonic welding) to body 18. In this regard, retainer 48 can be provided with tooling holes 51 to grip retainer 48 during the spin welding process.

End 24 of nozzle connector 26 is provided with a nipple 54 having a flange 56 creating an area 58 of lesser diameter. An O ring 60 on area 58 helps make the rotatable coupling between nozzle connector 26 and body 18 fluid tight. Upper end 22 of body 18 has a rim 62 for accommodating a retainer 64. In particular, retainer 64 has cutouts 66 so that retainer 64 can resiliently bend inward as it is introduced into upper end 22 of body 18 and resiliently snap back outward once it is inserted past rim 62. Similarly, retainer 64 can resiliently bend inward as it is introduced into end 24 of nozzle connector 26 and resiliently snap back outward once it is inserted sufficiently to be on the lesser diameter of area 58. To facilitate rotation of nozzle connector 26 relative to body 18, at least one of nozzle connector 26 and body 18 can be provided with knurling 68.

For manufacturing purposes, retainer 64 can be made integral to body 18. For example, using 3D printing, a single piece is formed in which retainer 64 is an integral part of body 18. Retainer 64 can also be made separately using, for example injection molding, in which retainer 64 is snapped into body 18 and then glued or welded (e.g. spin welding or ultrasonic welding) to body 18. In this regard, retainer 64 can be provided with tooling holes 65 to grip retainer 64 during the spin welding process.

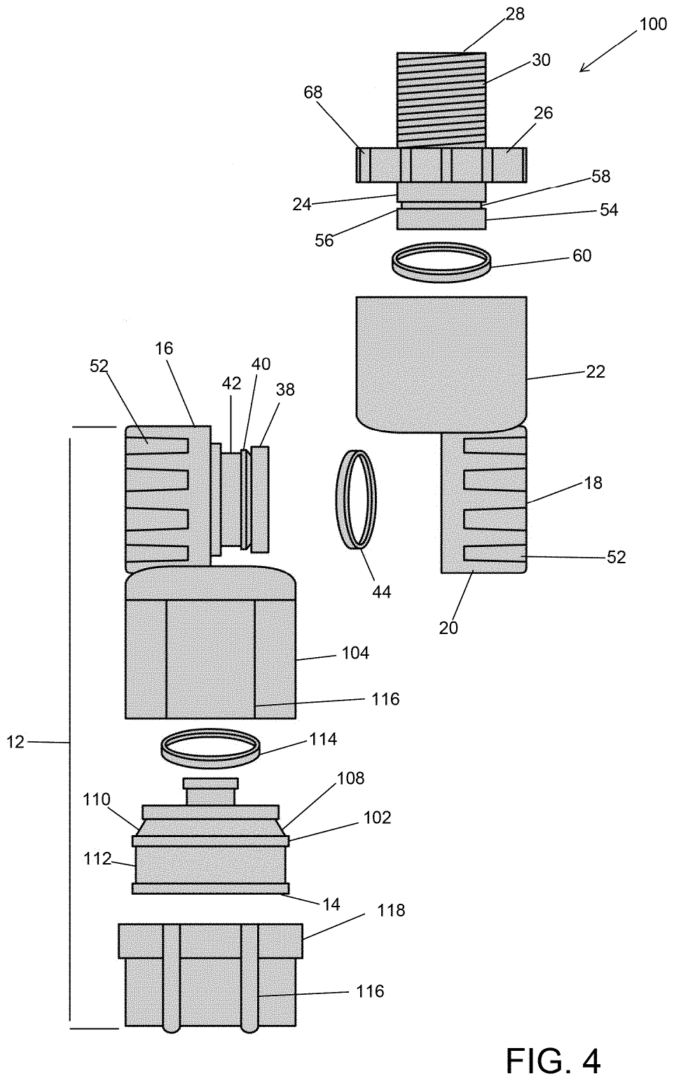

FIG. 4 is an exploded view of another embodiment of a high reach sprinkler head 100 according to the present invention. Since sprinkler head 100 is similar to sprinkler head 10, like components of sprinkler head 100 are identified with the same reference numerals used in connection with the above description of sprinkler head 10. Retainer 48 and retainer 64 are not shown in FIG. 4 since they are already inserted in body 18.

In addition to the pivotable connection between base 12 and body 18 and the rotatable connection between body 18 and nozzle connector 26, sprinkler head 100 provides a rotatable connection between base 12 and the irrigation line. The additional rotation between body 18 and nozzle connector 26 allows the entire sprinkler head 100 to rotate. This enables the pivot to be in line with the direction of the water from the nozzle which provides the flexibility to reach plants that are further away.

In this regard, base 12 comprises a first portion 102 and a second portion 104. First portion 102 includes threaded end 14 for connection to the irrigation line through which water or any other irrigation fluid is provided to sprinkler head 100. Second portion 104 includes end 16 so that second portion 104 of base 12 is pivotably connected to body 18 of sprinkler head 100. In preferred embodiments, body 18 can pivot anywhere from about 120 degrees to about 180 degrees relative to second portion 104 and, as a result, water plants several feet higher than current common sprinkler heads. This allows mounting of plant material in elevations many feet higher while still able to receive the needed water to be maintained. Because the pivot is adjustable, as opposed to current sprinkler heads that are mounted in a fixed position, sprinkler head 100 can pivot to account for continue growth of plants.

End 106 of first portion 102 is provided with a nipple 108 having a flange 110 creating an area 112 of lesser diameter. An O ring 114 on area 112 helps make the rotatable coupling between first portion 102 and second portion 104 fluid tight. A retainer analogous to retainer 48 and retainer 64 resiliently bends inward as it is introduced into second portion 104 and resiliently snaps back outward. Similarly, the retainer resiliently bends inward as it is introduced into first portion 102 and resiliently snaps back outward once it is inserted sufficiently to be on the lesser diameter of area 112. The retainer is not shown in FIG. 4 since it is already inserted in second portion 104. To facilitate rotation of first portion 102 relative to second portion 104, at least one of first and second portions 102, 104 can be provided with knurling 116. As shown in FIG. 4, a sleeve 118 covering first portion 102 is provided with knurling 116.

The high reach sprinkler head according to the present invention waters plants higher than conventional sprinkler heads. The high reach sprinkler head is able to water plants that are mounted to trees or other structures not rooted in soil. These plants obtain their water through above-ground roots or specialized leaves.

The high reach sprinkler head's adjustable pivot allows the user to customize the angle of spray and the desired height of the spray's reach. The user can customize the pivot at any time to water plants at different heights. The top section of the high reach sprinkler head rotates 360 degrees to allow the user to direct the water to multiple locations.

The present invention contemplates that high reach sprinkler head 10, 100 may be constructed from one or more different suitable materials based on considerations such as cost, expected operating environment (e.g. weather conditions, pressure requirements, etc.), desired durability, desired strength, ease and availability of manufacturing, etc. In particular, each of the respective constituent components may be constructed from materials including, but not limited to, polymers (with and without suitable additives such as a UV stabilizer) such as polyethylene, nylon, PVC, polypropylene and metals such as brass and stainless steel, or any other suitable materials as would be appreciated by one of ordinary skill in the art.

All references cited herein are expressly incorporated by reference in their entirety. It will be appreciated by persons skilled in the art that the invention is not limited to what has been particularly shown and described herein above. In addition, unless mention was made above to the contrary, it should be noted that all of the accompanying drawings are not to scale. There are many different features to the invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the invention set forth herein that are within the scope and spirit of the present invention are to be included as further embodiments of the invention.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the disclosure, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An adjustable sprinkler head comprising:
a base with a first end connectable to an irrigation line through which water is supplied to the sprinkler head and a second end opposite the first end;
a body pivotably connected to the second end of the base at a first end of the body so that the body is adjustably pivotable relative to the base; and
a nozzle connector rotatably connected at a first end to a second end of the body so that the nozzle connector is adjustably rotatable relative to the body,
wherein a nozzle is connectable to a second end of the nozzle connector, and
wherein the supplied water travels through a base conduit in the base into a body conduit in the body, then into a nozzle connector conduit in the nozzle connector, and out a nozzle connected to the nozzle connector.

2. The adjustable sprinkler head of claim 1, wherein the first end of the base is threaded for threadably connecting the base to the irrigation line.

3. The adjustable sprinkler head of claim 1, wherein the body is adjustably pivotable from about 120 degrees to about 180 degrees relative to the base.

4. The adjustable sprinkler head of claim 1, wherein the nozzle connector is adjustably rotatable 360 degrees relative to the body.

5. The adjustable sprinkler head of claim 1, wherein the second end of the nozzle connector is threaded for threadably connecting the nozzle connector to the nozzle.

6. The adjustable sprinkler head of claim 1, wherein the second end of the base includes a nub having a flange creating an area of lesser diameter and an O ring on the area,
wherein the first end of the body has a rim for accommodating a retainer,
wherein the retainer has cutouts so that the retainer is resiliently bendable inward as the retainer is introduced into the second end of the base and resiliently snappable back outward once the retainer is inserted sufficiently to be on the area of lesser diameter of the second end of the base.

7. The adjustable sprinkler head of claim 6, wherein the retainer is integrally formed with the body.

8. The adjustable sprinkler head of claim 6, wherein the retainer is resiliently bendable inward as the retainer is introduced into the first end of the body and resiliently snappable back outward once the retainer is inserted past the rim and wherein the retainer is welded or glued to the body.

9. The adjustable sprinkler head of claim 6, wherein at least one of the base and the body is provided with knurling.

10. The adjustable sprinkler head of claim 8, wherein a first end of the nozzle connector is provided with a nipple having a connector flange creating a nipple area of lesser diameter and an O ring on the nipple area,
wherein the second end of the body has a body rim for accommodating a body retainer,
wherein the body retainer has cutouts so that the body retainer is resiliently bendable inward as the body retainer is introduced into the first end of the nozzle connector and resiliently snappable back outward once the body retainer is inserted sufficiently to be on the lesser diameter of nipple area.

11. The adjustable sprinkler head of claim 10, wherein the body retainer is resiliently bendable inward as the body retainer is introduced into the second end of the body and resiliently snappable back outward once the body retainer is inserted past the body rim, and wherein the body retainer is welded or glued to the body.

12. The adjustable sprinkler head of claim 11, wherein at least one of the nozzle connector and the body is provided with knurling.

13. The adjustable sprinkler head of claim 11, wherein the body is adjustably pivotable from about 120 degrees to about 180 degrees relative to the base, and wherein the nozzle connector is adjustably rotatable about 360 degrees relative to the body.

14. The adjustable sprinkler head of claim 1, wherein a first end of the nozzle connector is provided with a nipple having a connector flange creating a nipple area of lesser diameter and an O ring on the nipple area,
wherein the second end of the body has a body rim for accommodating a body retainer,
wherein the body retainer has cutouts so that the body retainer is resiliently bendable inward as the body retainer is introduced into the second end of the body, resiliently snappable back outward once the body retainer is inserted past the body rim, and the body retainer is welded or glued to the body once inserted past the body rim, and
wherein the body retainer is resiliently bendable inward as the body retainer is introduced into the first end of the nozzle connector and resiliently snappable back outward once the body retainer is inserted sufficiently to be on the lesser diameter of nipple area.

15. The adjustable sprinkler head of claim 1, wherein the base comprises a first portion and a second portion, and
wherein the first portion includes the first end of the base connectable to the irrigation line so that the first portion is rotatable relative to the irrigation line and the second portion includes the second end of the base so that the second portion of the base is pivotably connected to the body.

16. The adjustable sprinkler head of claim 15, wherein a second end of the first portion is provided with a base nipple having a base flange creating an area of lesser diameter of the base nipple and an O ring on the area of the base nipple,
wherein a base retainer is resiliently bendable inward as the base retainer is introduced into the second portion and resiliently snappable back outward,
wherein the base retainer resiliently bends inward as the base retainer is introduced into the first portion and resiliently snappable back outward once the base retainer is inserted sufficiently to be on the lesser diameter of the area of the base nipple.

17. An adjustable sprinkler head comprising:
a base with a first end connectable to an irrigation line through which water is supplied to the sprinkler head and a second end opposite the first end;
a body pivotably connected to the second end of the base at a first end of the body so that the body is adjustably pivotable relative to the base; and
a nozzle connector rotatably connected at a first end to a second end of the body so that the nozzle connector is adjustably rotatable relative to the body,
wherein a nozzle is connectable to a second end of the nozzle connector,
wherein the supplied water travels through a base conduit in the base into a body conduit in the body, then into a nozzle connector conduit in the nozzle connector, and out a nozzle connected to the nozzle connector,
wherein the second end of the base includes a nub having a flange creating an area of lesser diameter and an O ring on the area,
wherein the first end of the body has a rim for accommodating a retainer,
wherein the retainer has cutouts so that the retainer is resiliently bendable inward as the retainer is introduced into the first end of the body, resiliently snappable back outward once the retainer is inserted past the rim, and the retainer is welded or glued to the body,
wherein the retainer is resiliently bendable inward as the retainer is introduced into the second end of the base and resiliently snappable back outward once the retainer is inserted sufficiently to be on the area of lesser diameter of the second end of the base,
wherein a first end of the nozzle connector is provided with a nipple having a connector flange creating a nipple area of lesser diameter and an O ring on the nipple area,
wherein the second end of the body has a body rim for accommodating a body retainer,
wherein the body retainer has cutouts so that the body retainer is resiliently bendable inward as the body retainer is introduced into the second end of the body, resiliently snappable back outward once the body retainer is inserted past the body rim, and the body retainer is welded or glued to the body once inserted past the body rim, and
wherein the body retainer is resiliently bendable inward as the body retainer is introduced into the first end of the nozzle connector and resiliently snappable back outward once the body retainer is inserted sufficiently to be on the lesser diameter of nipple area.

18. The adjustable sprinkler head of claim 17, wherein the body is adjustably pivotable from about 120 degrees to about 180 degrees relative to the base and the nozzle connector is adjustably rotatable 360 degrees relative to the body.
